(19) United States
(12) Patent Application Publication
(10) Pub. No.: US 2017/0094074 A1
(43) Pub. Date: Mar. 30, 2017

(54) TRANSMITTING DEVICE, TRANSMITTING METHOD, RECEIVING DEVICE, RECEIVING METHOD, TRANSMISSION SYSTEM, AND NON-TRANSITORY COMPUTER-READABLE STORAGE MEDIUM STORING PROGRAM

(71) Applicant: SONY CORPORATION, TOKYO (JP)

(72) Inventors: TAKASHI YOKOKAWA, KANAGAWA (JP); OSAMU SHINYA, KANAGAWA (JP); MASAKUNI MIYAMOTO, TOKYO (JP)

(21) Appl. No.: 15/126,700

(22) PCT Filed: Mar. 13, 2015
(86) PCT No.: PCT/JP2015/001404

§ 371 Date: Sep. 16, 2016

(30) Foreign Application Priority Data
Mar. 26, 2014 (JP) 2014-064702

(51) Int. Cl. H04N 1/00; G09G 5/00

(52) U.S. Cl. CPC H04N 1/00228; G09G 5/006; H04N 1/00129; G09G 2370/08; G09G 2370/04

(57) ABSTRACT

To transmit and receive phase detection image data together with visible image data through a standard of a DisplayPort (trademark). Information of phase detection pixels in lines L1 to L15 in which there are phase detection pixels set onto an effective pixel region 71 is arranged in a horizontal blanking region 73 as phase detection image data packet 83. The information of the phase detection image data packet is set onto a vertical blanking region 72 as phase detection image information packet 82. Thus, the phase detection image data is transmitted and received together with the visible image data generated by the effective pixel region 71. The present technology can be applied to the DisplayPort.

### TECHNICAL FIELD

The present technology relates to a transmitting device, a transmitting method, a receiving device, a receiving method, a transmission system, and a non-transitory computer-readable storage medium storing program, and more particularly, to a transmitting device, a transmitting method, a receiving device, a receiving method, a transmission system, and a non-transitory computer-readable storage medium storing program, which are capable of transmitting phase detection image data in addition to visible image data in a communication standard used for an existing DisplayPort interface.

### CROSS REFERENCE TO RELATED APPLICATIONS

This application claims the benefit of Japanese Priority Patent Application JP 2014-064702 filed on Mar. 26, 2014, the entire contents of which are incorporated herein by reference.

### BACKGROUND ART

A standard for an interface of transmitting image data to a display, that is, a standard called DisplayPort (trademark) has been popularized (for example, see Non-Patent Literature 1).

### CITATION LIST

### Non Patent Literature

[NPL 1]
DisplayPort (trademark) Version1.2a VESA (Video Electronics Standards Association)

### SUMMARY OF INVENTION

### Technical Problem

Meanwhile, in the DisplayPort (trademark) standard, transmission of audio data in addition to visible image data including effective pixel data is also specified, and it is possible to transmit and receive the audio data and the visible image data.

However, in the DisplayPort (trademark) standard, it is difficult to transmit and receive undefined data in addition to visible image data unless a new definition is given.

The present technology was made in light of the foregoing, and particularly, it is desirable to transmit phase detection image data in addition to visible image data in a communication standard (DisplayPort (trademark)) used in an existing DisplayPort interface.

### Solution to Problem

A transmitting device according to an aspect of the present technology is a transmitting device that transmits visible image data including effective pixel data of an imaging device using a format for transmission to a display, and includes a transmitting unit that transmits phase detection image data in the imaging device in addition to the visible image data.

It is possible to cause the transmitting unit to packetize and transmit the phase detection image data in the imaging device using the format for the transmission to the display.

The format for the transmission to the display is a format specified in a DisplayPort (trademark), and it is possible to cause the transmitting unit to packetize and transmit the phase detection image data in the imaging device using a secondary data packet (SDP) specified in the DisplayPort (trademark) as the format for the transmission to the display.

It is possible to cause the transmitting unit to packetize and transmit the phase detection image data in the imaging device using a phase detection image information packet and a phase detection image data packet of the SDP specified in the DisplayPort (trademark).

It is possible to cause the transmitting unit to arrange the phase detection image information packet in a vertical blanking region, arrange the phase detection image data packet in a horizontal blanking region, and packetize and transmit the phase detection image data.

It is possible to cause the phase detection image information packet to include information of the number of lines per frame, the number of pixels per line, and the number of bits per pixel of a phase detection image configured with the phase detection image data and the number of pixels per the phase detection image data.

It is possible to cause the transmitting unit to pack the phase detection image data packet in a certain byte unit and transmit the packed phase detection image data packet.

It is possible to cause the transmitting unit to transmit the phase detection image data in the imaging device in addition to the visible image data using a scheme in which a plurality of streams are transmitted from a plurality of stream sources to a plurality of stream sinks through one transmission path in the format for the transmission to the display.

A format specified in a DisplayPort (trademark) can be used as the format for the transmission to the display, and it is possible to cause the transmitting unit to transmit the phase detection image data in the imaging device in addition to the visible image data by transmitting a stream including the visible image data and a stream including the phase detection image data from the stream sources to the stream sinks through one transmission path using a virtual channel specified in the DisplayPort (trademark).

It is possible to cause a main stream attributes (MSA) that is individually for each stream of the virtual channel and is image characteristic information of the stream to include information of the number of lines per frame, the number of pixels per line, and the number of bits per pixel of a phase detection image configured with the phase detection image data when the steam is a stream including the phase detection image data.

It is possible to cause the MSA to further include information of Mvid (a video stream clock frequency) and Nvid (a link clock frequency), and when the number of pixels in the vertical direction and the number of pixels in the horizontal direction in the phase detection image including the phase detection image data can be 1/t and 1/s of the number of pixels in the vertical direction and the number of pixels in the horizontal direction of a visible image including the visible image data, respectively, a ratio of the Mvid and the Nvid of the MSA of the phase detection image data is 1/(t×s) of a ratio of the Mvid and the Nvid of the MSA of the visible image data.

It is possible to cause the MSA to further include information specifying the imaging device.

A transmitting method according to an aspect of the present technology is a transmitting method of a transmitting device that transmits visible image data including effective pixel data of an imaging device using a format for transmission to a display, and can include transmitting phase detection image data in the imaging device in addition to the visible image data.

A first non-transitory computer-readable storage medium storing program according to an aspect of the present technology causes a computer controlling a transmitting device that transmits visible image data including effective pixel data of an imaging device using a format for transmission to a display to execute a process including transmitting phase detection image data in the imaging device in addition to the visible image data.

A receiving device according to an aspect of the present technology is a receiving device that receives visible image data including effective pixel data of an imaging device using a format for transmission to a display, and includes a receiving unit that receives a phase detection image data in the imaging device in addition to the visible image data.

A receiving method according to an aspect of the present technology is a receiving method of a receiving device that receives visible image data including effective pixel data of an imaging device using a format for transmission to a display, and includes receiving a phase detection image data in the imaging device in addition to the visible image data.

A second non-transitory computer-readable storage medium storing program according to an aspect of the present technology causes a computer controlling a receiving device that receives visible image data including effective pixel data of an imaging device using a format for transmission to a display to execute a process including receiving a phase detection image data in the imaging device in addition to the visible image data.

A transmission system according to an aspect of the present technology is a transmission system including a transmitting device that transmits visible image data including effective pixel data of an imaging device using a format for transmission to a display and a receiving device, wherein the transmitting device includes a transmitting unit that transmits phase detection image data in the imaging device in addition to the visible image data, and the receiving device includes a receiving unit that receives a phase detection image data in the imaging device in addition to the visible image data from the transmitting device.

According to an aspect of the present technology, when visible image data including effective pixel data of an imaging device is transmitted using a format for transmission to a display, the transmitting device transmits phase detection image data in the imaging device in addition to the visible image data to the receiving device, and the receiving device receives the phase detection image data in the imaging device in addition to the visible image data from the transmitting device.

The transmitting device and the receiving device according to an aspect of the present technology may be independent devices or may be blocks performing a transmission process.

### Advantageous Effects of Invention

According to an aspect of the present technology, it is possible to transmit phase detection image data in addition to visible image data in a communication standard used in an existing DisplayPort interface.

### BRIEF DESCRIPTION OF DRAWINGS

FIG. 1 is a diagram illustrating an exemplary configuration of a transmission system according to a first embodiment of the present technology.

FIG. 2 is a diagram for describing a ZAF pixel.

FIG. 3 is a diagram for describing an MSA and an SDP.

FIG. 4 is a diagram for describing an MSA and an SDP.

FIG. 5 is a diagram for describing a configuration of a phase detection image information packet of an SDP.

FIG. 6 is a diagram for describing a transmission format of a phase detection image information packet of an SDP.

FIG. 7 is a diagram for describing a configuration and a transmission format of a phase detection image data packet of an SDP.

FIG. 8 is a diagram for describing a transmission format of an MSA.

FIG. 9 is a diagram for describing a configuration of an MSA.

FIG. 10 is a diagram for describing a configuration of an MSA.

FIG. 11 is a flowchart for describing a transceiving process performed by the transmission system of FIG. 1.

FIG. 12 is a diagram illustrating an exemplary configuration of a transmission system according to a second embodiment of the present technology.

FIG. 13 is a diagram for describing a ZAF image.

FIG. 14 is a diagram for describing a virtual channel.

FIG. 15 is a diagram for describing a comparison of an MSA between a visible image and a ZAF image.

FIG. 16 is a flowchart for describing a transceiving process performed by the transmission system of FIG. 11.

FIG. 17 is a diagram for describing an exemplary configuration of a general-purpose personal computer.

### DESCRIPTION OF EMBODIMENTS

The description will proceed in the following order.

1. First embodiment (example using secondary data packet)
2. Second embodiment (example using virtual channel)

### 1. First Embodiment

### Exemplary Configuration of Transmission System Using Secondary Data Packet

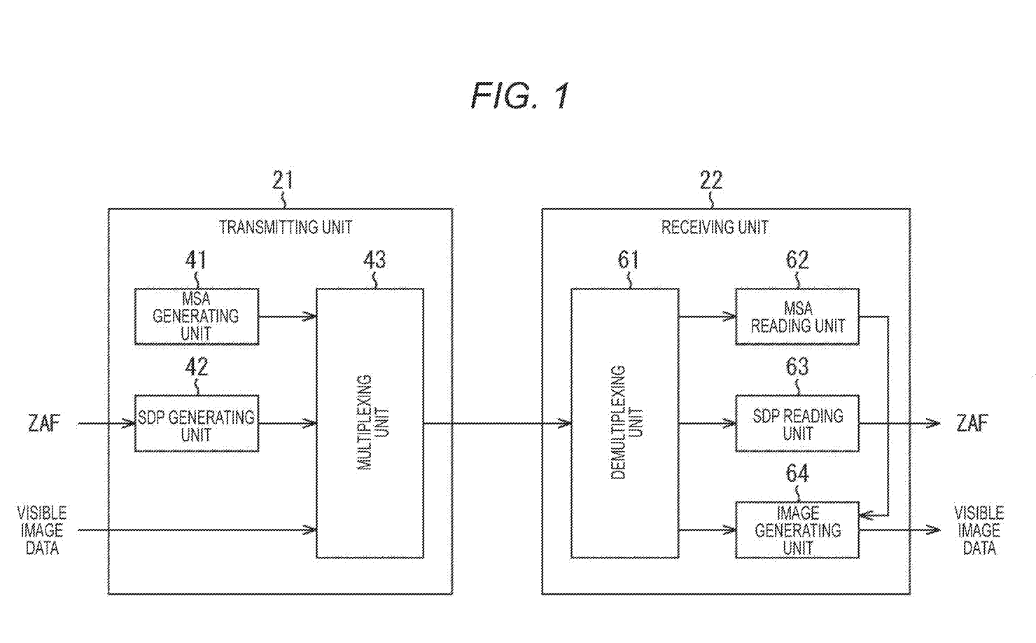

FIG. 1 illustrates an exemplary configuration of a transmission system according to an embodiment of the present technology. The transmission system of FIG. 1 is a system that transmits image data generated (imaged) by an imaging device (not illustrated).

More specifically, the transmission system of FIG. 1 includes a transmitting unit 21 and a receiving unit 22. The transmitting unit 21 transmits phase detection image data (ZAF image data) to the receiving unit 22 in a format called a secondary data packet (SDP) of the DisplayPort (trademark) that is a standard for transmission to a display in addition to visible image data supplied from an imaging device (not illustrated). The receiving unit 22 receives the phase detection image data together with the visible image data transmitted from the transmitting unit 21. Hereinafter, a phase detection image is also referred to as a “ZAF image.” Further, in this specification, an image is assumed to be configured with a plurality of pixels, and image data is assumed to be configured with pixel data serving as data such as pixels values of a plurality of pixels.

<ZAF Pixel>

Among pixels set to an imaging region, ZAF pixels are arranges at certain intervals in addition to effective pixels generating visible image data. As ZAF pixels, there are a left light-shielding pixel in which a left half of a pixel is light-shielded and a right light-shielding pixel in which a right half of a pixel is light-shielded, and images imaged by the pixels deviate from side to side according to a focal length. For this reason, for an image at a focal point, an image in a left light-shielding pixel matches an image in a right light-shielding pixel, but for an image deviated from a focal point, a phase difference according to a deviation amount of a focal length occurs between the respective images. In this regard, focusing can be performed at a high speed by obtaining the deviation amount of the focal length based on the phase difference and performing focusing.

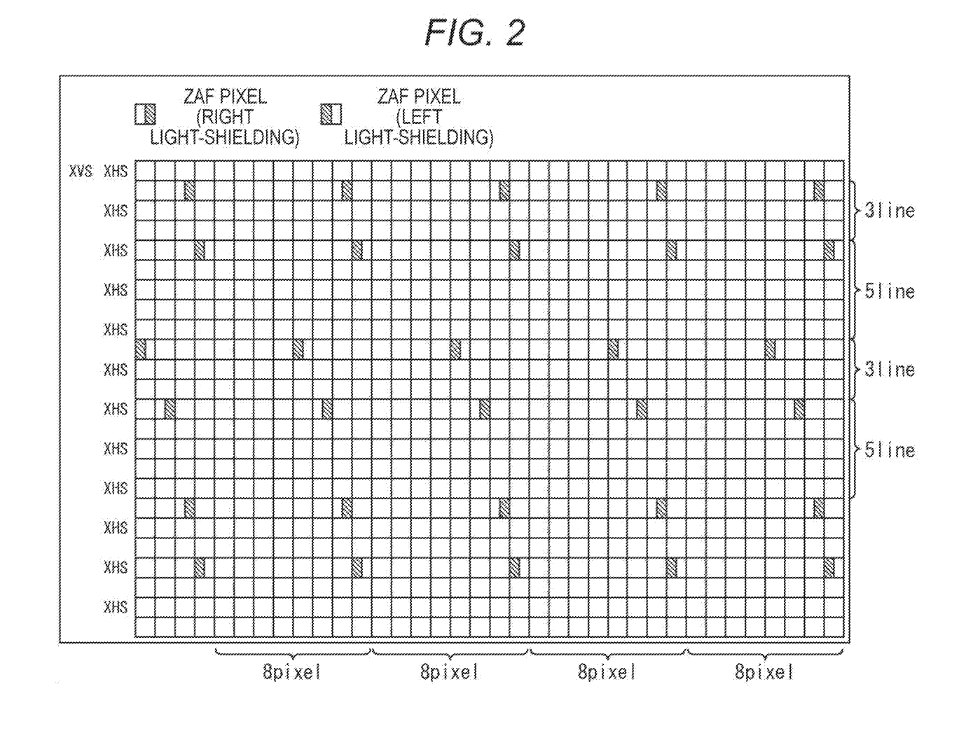

The ZAF pixels are arranged, for example, as illustrated in FIG. 2. FIG. 2 illustrates an exemplary pixel array in an effective pixel region. Referring to FIG. 2, each cell indicates a pixel, white cells are normal RGB pixels, and cells in which a light-shielding portion indicated by a hatching portion is formed in a left or right half region are ZAF pixels. As described above, the ZAF pixels are arranged at alternating intervals of 3 lines and 5 lines in a vertical direction and 8-pixel intervals in a horizontal direction. For this reason, in the example of FIG. 2, the number of ZAF pixels is one eighth (⅛) of the number of all pixels in the effective pixel region in the horizontal direction and one fourth (¼) of the number of all pixels of the effective pixel region in the vertical direction. Thus, in the example of FIG. 2, the number of ZAF pixels is one thirty second ( 1/32) of the number of all pixels in the effective pixel region.

Next, configurations of the transmitting unit 21 and the receiving unit 22 of the transmission system of FIG. 1 will be described.

The transmitting unit 21 includes an MSA generating unit 41, an SDP generating unit 42, and a multiplexing unit 43.

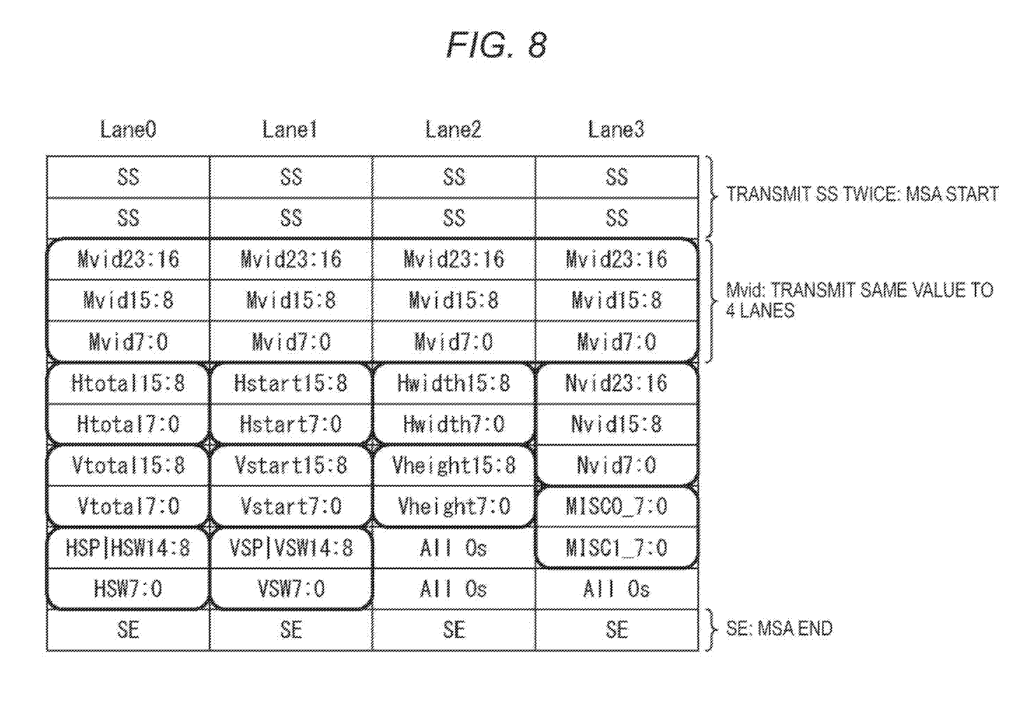

The MSA generating unit 41 generates main stream attributes (MSA) serving as image characteristic information such as the number of lines per frame, the number of pixels per line, and the number of bits per pixel of image data (visible image data) including effective pixel data that is desired to be transmitted, and supplies the generated MSA to the multiplexing unit 43. The details of the MSA will be described later with reference to FIGS. 8 to 10.

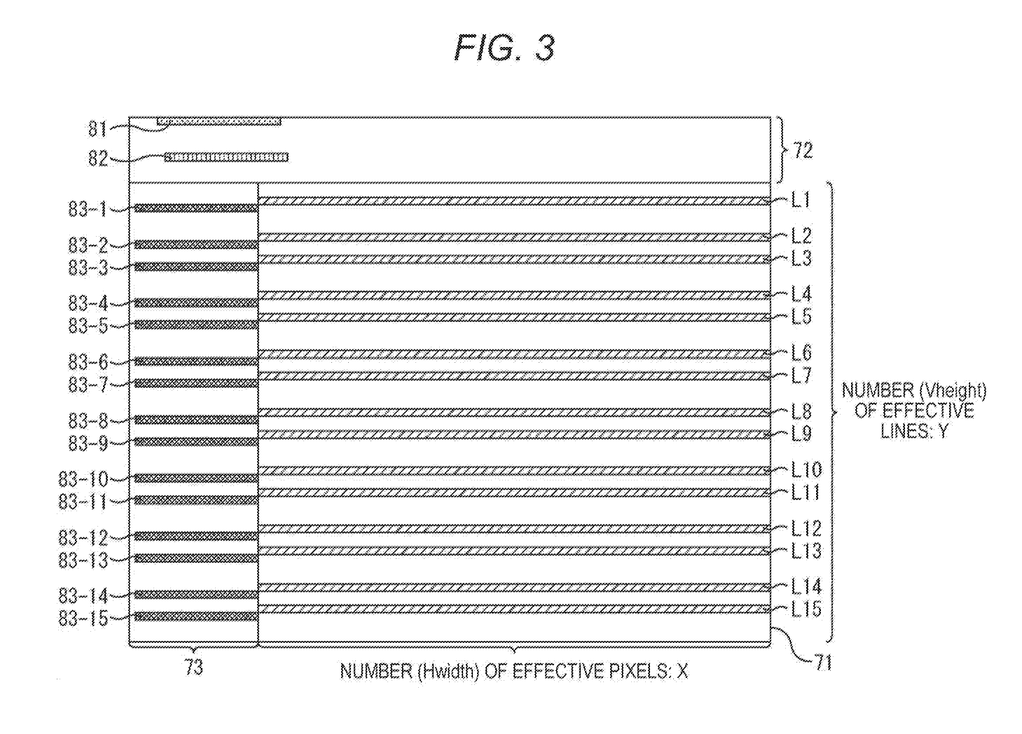

The SDP generating unit 42 generates a packet having a format for packetizing ZAF pixel data into a horizontal blanking region and a vertical blanking region other than an effective pixel region and transmitting the packetized data, that is, a packet called an SDP, and supplies the generated packet to the multiplexing unit 43. The details of the SDP will be described later with reference to FIGS. 3 to 7.

The multiplexing unit 43 multiplexes the MSA supplied from the MSA generating unit 41, the SDP supplied from the SDP generating unit 42, and image data (visible image data) including input effective pixel data, and outputs multiplexed data.

The receiving unit 22 includes a demultiplexing unit 61, an MSA reading unit 62, an SDP reading unit 63, and an image generating unit 64. The demultiplexing unit 61 demultiplexes the multiplexed data transmitted from the transmitting unit 21 into the MSA, the SDP, and the visible image data, and supplies the MSA, the SDP, and the visible image data to the MSA reading unit 62, the SDP reading unit 63, and the image generating unit 64, respectively.

The MSA reading unit 62 reads information of the number of lines per frame, the number of pixels per line, and the number of bits per pixel of the visible image data based on the supplied MSA, and supplies the read information to the image generating unit 64.

The SDP reading unit 63 reads the SDP, and extracts and outputs the packetized ZAF image data.

The image generating unit 64 acquires the visible image data, reconstructs the visible image based on the information of the MSA, and outputs the reconstructed visible image.

<SDP>

Next, the SDP will be described.

The SDP is a packet for packetizing and transmitting data other than visible image data (effective pixel data) using a horizontal blanking region and a vertical blanking region for each frame. As the SDP, there are two types of packets, that is, a phase detection image information packet and a phase detection image data packet.

The phase detection image information packet is a packet including information of the number of lines per frame, the number of pixels per line, the number of bits per pixel, and the number of pixels per ZAF pixel data of ZAF image data.

The phase detection image data packet is a packet configuring a plurality of pieces of ZAF pixel data.

The phase detection image information packet and the phase detection image data packet are packetized data arranged in an image of one frame, for example, as illustrated in FIG. 3.

Referring to FIG. 3, a region of ((the number of effective pixels (Hwidth): X)×(the number of effective lines (Vheight): Y)) indicated in a lower right portion is an effective pixel region 71. In the effective pixel region 71, lines L1 to L15 are lines in which there are ZAF pixels, and when intervals between lines is the same as in FIG. 2, an interval between the lines L1 and L2 is 5 lines, an interval between the lines L2 and L3 is 3 lines, and then intervals of 3 lines and intervals of 5 lines are alternately repeated.

There is a vertical blanking region (Vblank) 72 above the effective pixel region 71, and a phase detection image information packet 82 is arranged between an MSA 81 and the SDP.

There is a horizontal blanking region (Hblank) 73 at the left side of the effective pixel region 71, and phase detection image data packets 83-1 to 83-15 are arranged below lines in which there is the ZAF pixel in the effective pixel region 71, respectively. Thus, the lines in which the phase detection image data packets 83-1 to 83-15 are arranged at alternating intervals of 3 lines and 5 lines in the vertical direction. Here, when it is unnecessary to particularly distinguish the phase detection image data packets 83-1 to 83-15 from one another, they are referred to simply as a “phase detection image data packet 83,” and the same applies to the other components.

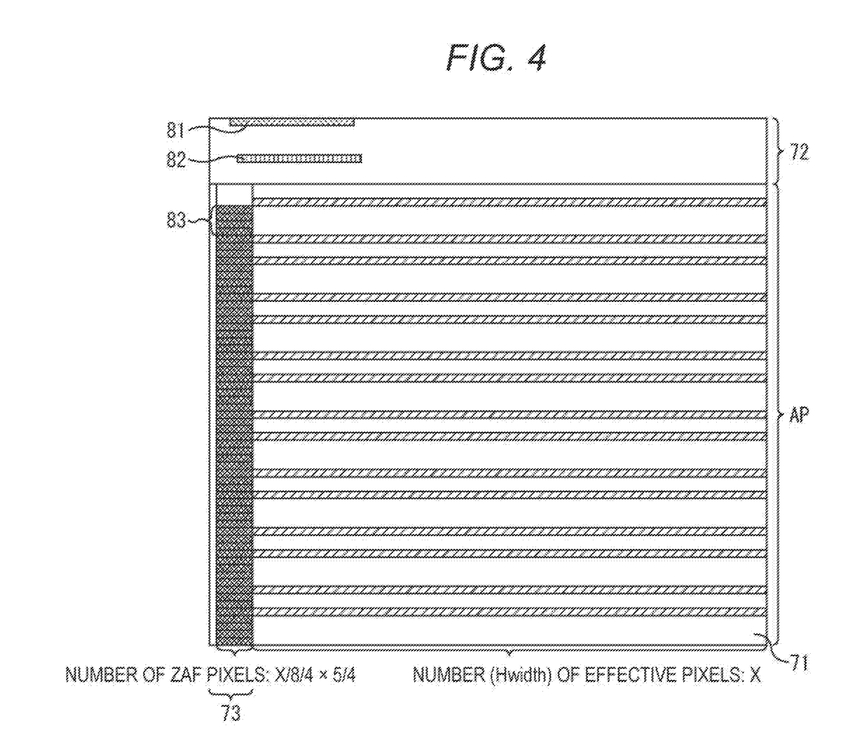

Thus, in FIG. 3, the phase detection image data packet 83 occupies about one fourth (¼) of the horizontal blanking region (Hblank) 73. In this regard, the phase detection image data packet 83 is divided into four and folded and arranged in the lines in which the phase detection image data packet 83 is not arranged, and thus the phase detection image data packet 83 is arranged, for example, as illustrated in FIG. 4. Through this arrangement, the horizontal blanking region (Hblank) 73 necessary for the phase detection image data packet 83 can be reduced to be one fourth (¼) in the horizontal direction.

<Configuration of Phase Detection Image Information Packet>

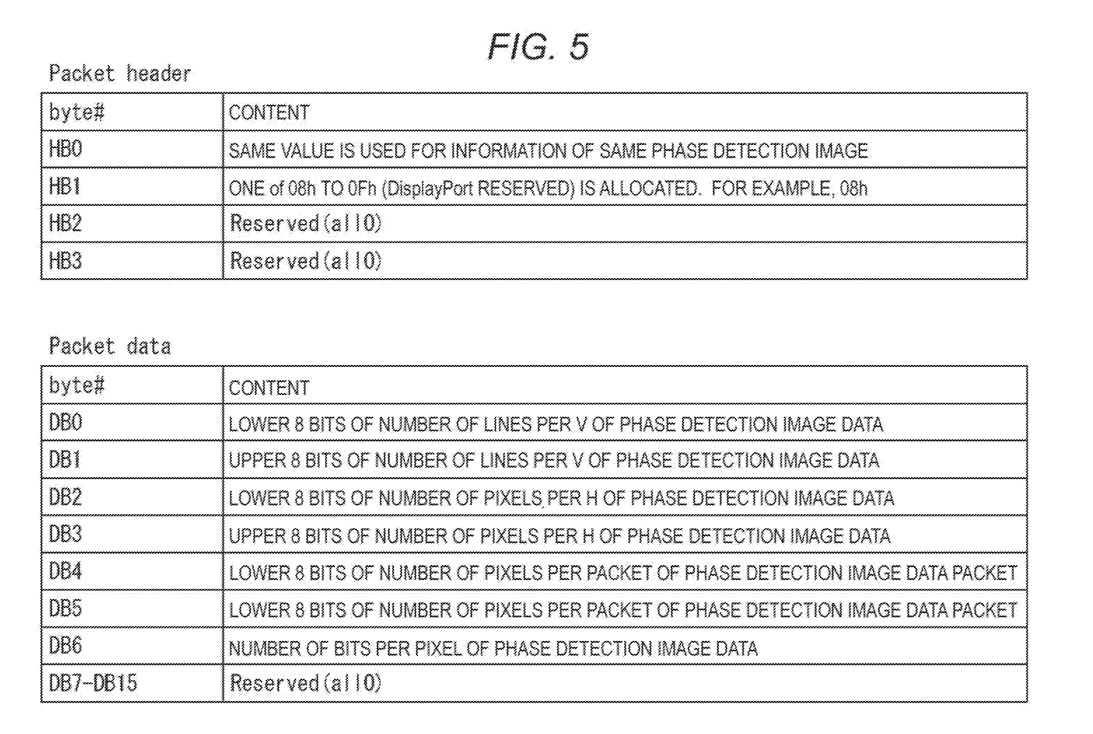

Next, a configuration of the phase detection image information packet 82 will be described with reference to FIG. 5. A packet header of the SDP specified in the DisplayPort (trademark) is configured with 4 bytes of HB0 to HB3 indicated in the upper portion of FIG. 5. Information identifying a phase detection image being dealt is recorded in HB0 serving as a first byte. Thus, the same value is used for the same phase detection image.

Information indicating a packet type (an SDP type) is recorded in HB1 serving as a second byte. In HB1, in order to specify a display type in advance, 00h to 07h are set as a certain display type, but h08 to 0Fh are not set (DisplayPort RESERVED). In this regard, information indicating the phase detection image information packet is allocated to any one of non-set 08h to 0Fh. For example, 08h may be allocated as the information indicating the phase detection image information packet.

HB2 and HB3 serving as third and fourth bytes are unused bytes (Reserved (all 0)).

In data packet of the phase detection image information packet, as illustrated in the lower portion of FIG. 5, information of lower 8 bits of the number of lines per V of the phase detection image data is recorded in DB0 serving as a first byte. Further, information of upper 8 bits of the number of lines per V of the phase detection image data is recorded in DB1 serving as a second byte. Here, for example, the number of lines per V refers to the number of lines of the lines L1 to L15 illustrated in FIG. 3.

Information of lower 8 bits of the number of pixels per H of the phase detection image data is recorded in DB2 serving as a third byte. Further, information of upper 8 bits of the number of pixels per H of the phase detection image data is recorded in DB3 serving as a fourth byte. Here, for example, the number of pixels per H refers to the number of phase detection pixels included in the lines L1 to L15 illustrated in FIG. 3.

Information of lower 8 bits of the number of pixels per packet of the phase detection image data packet is recorded in DB4 serving as a fifth byte. Further, information of upper 8 bits of the number of pixels per packet of the phase detection image data packet is recorded in DB5 serving as a sixth byte.

Information of the number of bits per pixel of the phase detection image data packet is recorded in DB6 serving as a seventh byte. Further, DB7 to DB15 of 8-th to 16-th bytes are set as unused regions (Reserved (all 0)).

<Transmission Format>

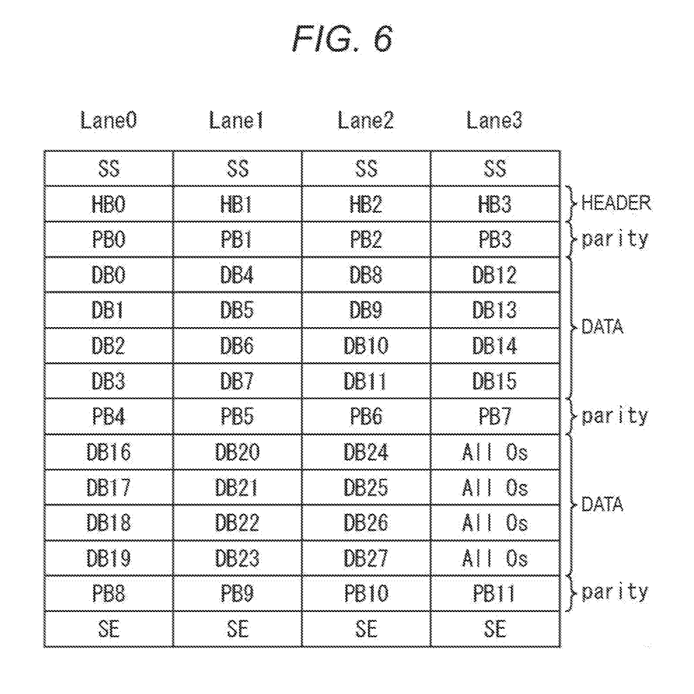

Next, a transmission formation of the SDP will be described with reference to FIG. 6. The following description will proceed with an example in which the number of lanes is 4, but the number of lanes may be any other number.

FIG. 6 illustrates a transmission format of data chronologically arranged downward in lanes 0 to 3 arranged rightward. Below SSs indicating the start of the SDP, headers HB0 to HB3 are configured from the lane 0 to the lane 3, and one byte is arranged for each lane.

In FIG. 6, below the headers HB0 to HB3, parities PB0 to PB3 are configuration, and one byte is arranged for each lane from the lane 0 to the lane 3.

In FIG. 6, below the parities PB0 to PB3, data DB0 to DB15 are arranged such that 4 bytes are arranged downward for each lane, and thus a total of 16 bytes are arranged. In other words, data DB0 to DB3 are arranged for the lane 0, data DB4 to DB7 are arranged for the lane 1, DB8 to DB11 are arranged for the lane 2, and DB12 to DB15 are arranged for the lane 3.

In FIG. 6, below the data DB0 to DB15 of the respective lanes, parities PB4 to PB7 are configured, and one byte is arranged for each lane from the lane 0 to the lane 3.

Further, in FIG. 6, data DB16 to DB27 are arranged for the lanes 0 to 2 below the parities PB4 to PB7 such that 4 bytes are arranged downward for each lane. In other words, data DB16 to DB19 are arranged downward for the lane 0, DB20 to DB23 are arranged downward for the lane 1, and DB24 to DB27 are arranged downward for the lane 2. Here, since data to be transmitted is 28 bytes, All 0s are arranged for the lane 3 and regarded as blanks.

Further, below data of the respective lanes, parities PB8 to PB11 are configured, and one byte is arranged for each lane from the lane 0 to the lane 3. In the lowest portion, SEs indicating the end of the SDP is arranged for each lane.

As described above, data of 16 bytes with parities of 4 bytes added thereto are transmitted.

<Exemplary Configuration of Phase Detection Image Data Packet>

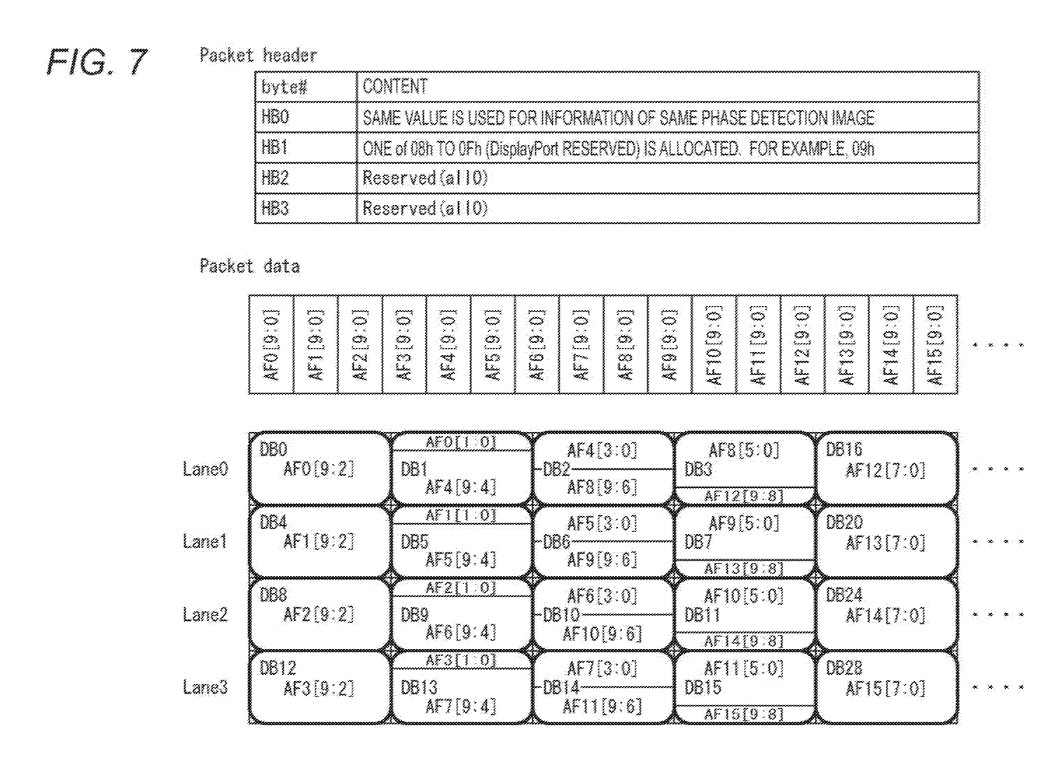

Next, an exemplary configuration of the phase detection image data packet will be described with reference to FIG. 7. Here, a packet header of the phase detection image data packet has the same configuration as the phase detection image information packet described above with reference to FIG. 5 as illustrated in the upper portion of FIG. 7. Here, any one of non-set (DisplayPort RESERVED) values of h08 to 0Fh is allocated to information indicating a display type in a header HB1 serving as a second byte. For example, 09h may be allocated as information indicating the phase detection image data packet.

In the data packet of the phase detection image data packet, ZAF pixel data are sequentially stored in the data DB0 to DB15.

For example, when 10-bit ZAF pixel data AF0[9:0] to AF15[9:0] . . . each of which includes data of 0-th to 9-th bits are configured from the left of FIG. 7 as illustrated in the middle of FIG. 7, ZAF pixel data are allocated to data DB0 to DB15 by 8 bits and then transmitted as illustrated in the lower portion of FIG. 7. Here, the lower portion of FIG. 7 illustrates a data arrangement when transmission is performed through 4 lanes, that is, a lane 0 to a lane 3 arranged downward. Here, [9:0] indicates a first bit (0) to a 10-th bit (9).

In other words, for the lane 0, AF1[9:2] of 1-st ZAF pixel data AF0[9:0] is allocated to data DB0 serving as a first byte in a left-to-right order in FIG. 7.

8 bits including AF0[1:0] of 1-st ZAF pixel data AF0[9:0] and AF4[9:4] of 5-th ZAF pixel data AF4[9:0] are allocated to data DB1 serving as a second byte of the lane 0.

8 bits including AF4[3:0] of 5-th ZAF pixel data AF4[9:0] and AF8[9:6] of 9-th ZAF pixel data AF8[9:0] are allocated to data DB2 serving as a third byte of the lane 0.

8 bits including AF8[5:0] of 9-th ZAF pixel data AF8[5:0] and 13-th ZAF pixel data AF12[9:8] are allocated to data DB3 serving as a fourth byte of the lane 0.

8 bits of 13-th ZAF pixel data AF12[7:0] are allocated to data DB16 serving as a fifth byte of the lane 0.

Further, in the lane 1, 8 bits of 2-nd ZAF pixel data AF1[9:2] are allocated to data DB4 of a first byte.

8 bits including 2-nd ZAF pixel data AF1[1:0] and 6-th ZAF pixel data AF5[9:4] are allocated to data DB5 serving as a second byte of the lane 1.

8 bits including 6-th ZAF pixel data AF5[3:0] and 10-th ZAF pixel data AF9[9:6] are allocated to data DB6 serving as a third byte of the lane 1.

8 bits including 10-th ZAF pixel data AF9[5:0] and 14-th ZAF pixel data AF13[9:8] are allocated to data DB7 serving as a fourth byte of the lane 1.

8 bits including 14-th ZAF pixel data AF13[7:0] are allocated to data DB20 serving as a fifth byte of the lane 1.

Further, in the lane 2, 8 bits of 3-rd ZAF pixel data AF2[9:2] are allocated to data DB8 of a first byte.

8 bits including 3-rd ZAF pixel data AF2[1:0] and 7-th ZAF pixel data AF6[9:4] are allocated to data DB9 serving as a second byte of the lane 2.

8 bits including 7-th ZAF pixel data AF6[3:0] and 11-th ZAF pixel data AF10[9:6] are allocated to data DB6 serving as a third byte of the lane 2.

8 bits including 11-th ZAF pixel data AF10[5:0] and 15-th ZAF pixel data AF14[9:8] are allocated to data DB11 serving as a fourth byte of the lane 2.

8 bits of 15-th ZAF pixel data AF14[7:0] are allocated to data DB24 serving as a fifth byte of the lane 2.

Further, in the lane 3, 8 bits of 4-th ZAF pixel data AF3[9:2] are allocated to data DB12 serving as a first byte.

8 bits including 4-th ZAF pixel data AF3[1:0] and 8-th ZAF pixel data AF7[9:4] are allocated to data DB13 serving as a second byte of the lane 3.

8 bits including 8-th ZAF pixel data AF7[3:0] and 12-th ZAF pixel data AF11[9:6] are allocated to data DB14 serving as a third byte of the lane 3.

8 bits including 12-th ZAF pixel data AF11[5:0] and 16-th ZAF pixel data AF15[9:8] are allocated to data DB15 serving as a fourth byte of the lane 3.

8 bits of 16-th ZAF pixel data AF15[7:0] are allocated to data DB28 serving as a fifth byte of the lane 3.

Here, a transmission format is the same as that of the phase detection image information packet described above with reference to FIG. 6, and thus a description thereof is omitted.

In other words, it is possible to packetize, transmit, and receive the ZAF pixel data using the format based on the SDP.

<MSA>

Next, the MSA will be described with reference to FIGS. 8 to 10.

The MSA has an arrangement illustrated in FIG. 8 at the time of transmission. FIG. 8 illustrates an exemplary arrangement of the MSA when the number of lanes is 4, that is, a lane 0 to a lane 3 are arranged rightward, and a downward arrangement is chronological.

For each lane, an SS indicating the start of the MSA is arranged twice consecutively.

Next, Mvid23:16, Mvid15:8, and Mvid7:0 indicating a clock frequency of the same video stream are arranged downward by one byte. Here, Mvid is information of a clock frequency of a video stream, and Mvid23:16 is information 16-th to 23-th bits of a clock frequency of a video stream. Further, Mvid15:8 is information of 8-th to 15-th bits of a clock frequency of a video stream. Furthermore, Mvid7:0 is information of 0-th to 7-th bits of a clock frequency of a video stream.

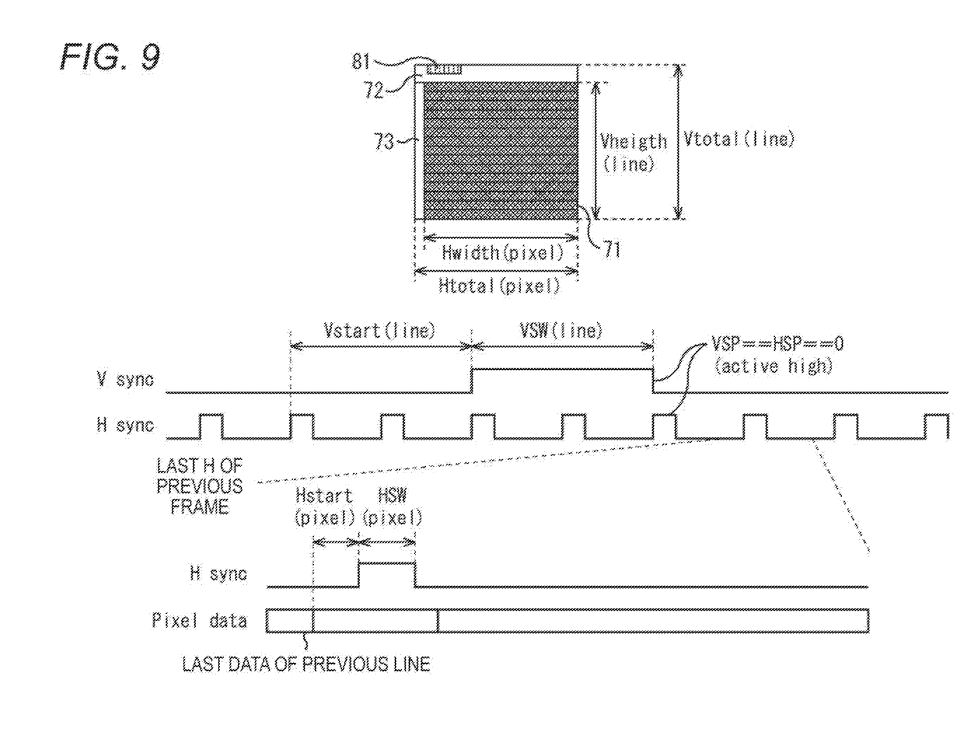

For a lane 0, Htotal15:8 and Htotal7:0 are arranged below Mvid by one byte. Htotal is the number of pixels in the horizontal direction obtained by adding the effective pixel region 71 to the horizontal blanking region 73 as illustrated in the upper portion of FIG. 9. Htotal15:8 and Htotal7:0 are information of 8-th to 15-th bits of Htotal and information of 0-th to 7-th bits of Htotal, respectively.

For the lane 0, Vtotal15:8 and Vtotal7:0 are arranged below Htotal by one byte. Vtotal is the number of lines in the vertical direction obtained by adding the number of effective lines of the effective pixel region 71 to the vertical blanking region 72 as illustrated in the upper portion of FIG. 9. Vtotal15:8 and Vtotal7:0 are information of 8-th to 15-th bits of Vtotal and information of 0-th to 7-th bits of Vtotal.

For the lane 0, HSP/HSW14:8 and HSW7:0 are arranged by one byte below Vtotal. HSP is 1-bit information indicating a polarity of Hsync (a horizontal synchronous signal), and 0 indicates an active high, and 1 indicates an active low as illustrated in the middle of FIG. 9. HSW indicates a pulse width of Hsync. HSP/HSW14:8 are 1-bit information of HSP and information of 8-th to 14-th bits of HSW, and HSW7:0 is information of 0-th to 7-th bits of HSW.

For the lane 1, Hstart15:8 and Hstart7:0 are arranged below Mvid by one byte. Hstart is the number of pixels specifying a period of time from a timing at which last data (last data of a previous line) of a previous line ends to a timing at which Hsync rises as illustrated in the lower portion of FIG. 9. Hstart15:8 and Hstart7:0 are information of 8-th to 15-th bits of Hstart and information of 0-th to 7-th bits of Hstart.

For the lane 1, Vstart15:8 and Vstart7:0 are arranged below Hstart by one byte. Vstart is the number of lines specifying a period of time from a timing at which last Hsync (last H of a previous frame) of a previous frame rises to a timing at which Vsync (a vertical synchronous signal) rises as illustrated in the middle of FIG. 9. Vstart15:8 and Vstart7:0 are information of 8-th to 15-th bits of Vstart and information of 0-th to 7-th bits of Vstart.

For the lane 1, VSP/VSW14:8 and VSW7:0 are arranged below Vstart by one byte. VSP is 1-bit information indicating a polarity of Vsync (a vertical synchronous signal), and 0 indicates an active high, and 1 indicates an active low as illustrated in the middle of FIG. 9. VSW indicates a pulse width of Vsync. VSP/VSW14:8 are 1-bit information of VSP and information of 8-th to 14-th bits of VSW, and VSW7:0 is information of 0-th to 7-th bits of VSW.

Meanwhile, for the lane 2, Hwidth15:8 and Hwidth7:0 are arranged below Mvid by one byte. Hwidth is the number of pixels of the effective pixel region 71 in the horizontal direction as illustrated in the upper portion of FIG. 9. Hwidth5:8 and Hwidth7:0 are information of 8-th to 15-th bits of Hwidth and information of 0-th to 7-th bits of Hwidth.

For the lane 2, Vheight15:8 and Vheight7:0 are arranged below Hwidth by one byte. Vheight is the number of lines of the effective pixel region 71 in the vertical direction as illustrated in the upper portion of FIG. 9. Vheight5:8 and Vheight7:0 are information of 8-th to 15-th bits of Hheight and information of 0-th to 7-th bits of Hheight. Here, for the lane 2, 2 bytes below Vheight are set as blanks (All 0s).

For the lane 3, Nvid23:16, Nvid15:8, and Nvid7:0 are arranged below Mvid by one byte. Nvid is a link clock frequency. Nvid23:16, Nvid15:8, and Nvid7:0 are information of 23-rd to 16-th bits of Nvid, information of 8-th to 15-th bits of Nvid, and information of 0-th to 7-th bits of Nvid.

Here, Video Stream clock[Mz]=Mvid/Nvid×Link clock[Mz].

For the lane 3, MISC0_7:0 and MISC1_7:0 are arranged below Nvid downward by one byte. MISC0_7:0 and MISC1_7:0 are information of an encoding format.

<Encoding Format Indicated by MISC>

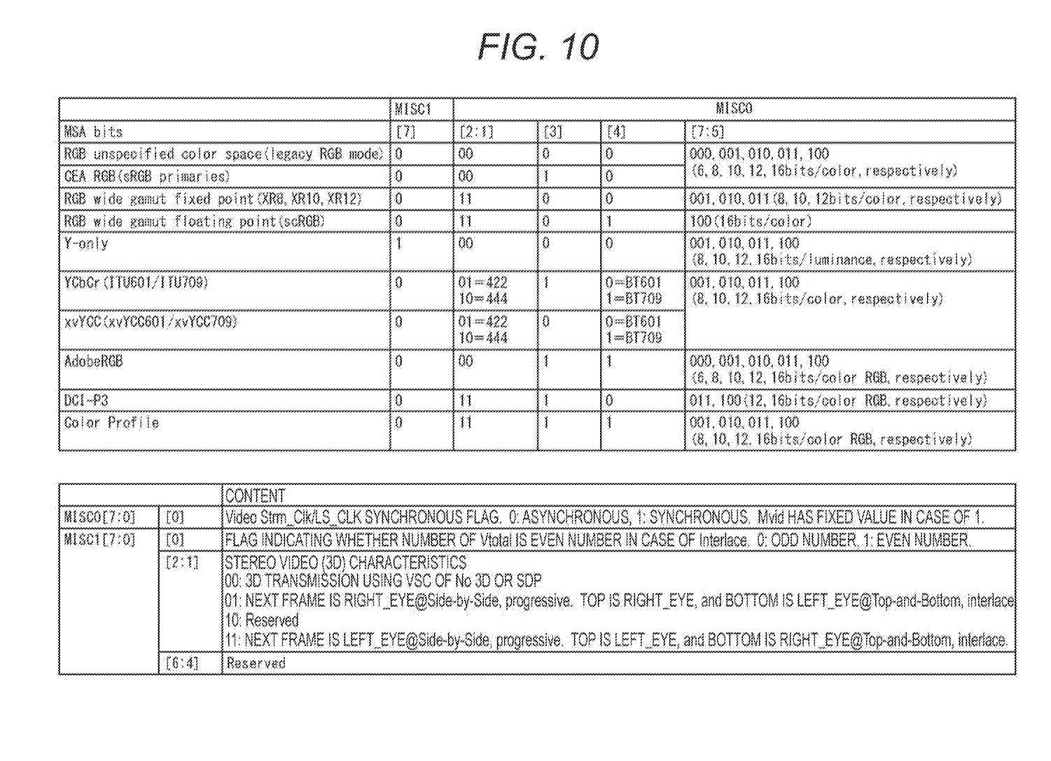

MISC0_7:0 and MISC1_7:0 record, for example, information of an encoding format indicated by FIG. 10.

In other words, as illustrated in the first line of the upper portion of FIG. 10, when a 7-th bit of MISC1 is 0, and 1-st to 4-th bits of MISC0 are 0000, it indicates that a format is an RGB unspecified color space (legacy RGB mode). Further, when 5-th to 7-th bits of MISC0 are 000, 001, 010, 011, and 100, 000, 001, 010, 011, and 100 indicate 6-bit, 8-bit, 10-bit, 12-bit, and 16-bit colors, respectively.

As illustrated in the second row of the upper portion of FIG. 10, when the 7-th bit of MISC1 is 0, and the 1-st to 4-th bits of MISC0 are 0010, it indicates that a format is a CEA RGB (sRGB primaries). Further, when the 5-th to 7-th bits of MISC0 are 000, 001, 010, 011, and 100, 000, 001, 010, 011, and 100 indicate G-bit, 8-bit, 10-bit, 12-bit, and 16-bit colors, respectively.

As illustrated in the third row of the upper portion of FIG. 10, when the 7-th bit of MISC1 is 0, and the 1-st to 4-th bits of MISC0 are 1100, it indicates that a format is an RGB wide gamut fixed point (XR8, XR10, XR12). Further, when the 5-th to 7-th bits of MISC0 are 001, 010, and 011, 001, 010, and 011 indicate 8-bit, 10-bit, 12-bit, and 16-bit colors, respectively.

As illustrated in the fourth row of the upper portion of FIG. 10, when the 7-th bit of MISC1 is 0, and the 1-st to 4-th bits of MISC0 are 1101, it indicates that a format is an RGB wide gamut fixed point (scRGB). Further, when the 5-th to 7-th bits of MISC0 are 100, 100 indicate a 16-bit color.

As illustrated in the fifth row of the upper portion of FIG. 10, when the 7-th bit of MISC1 is 1, and the 1-st to 4-th bits of MISC0 are 0000, it indicates that a format is a Y-only (only brightness). Further, when the 5-th to 7-th bits of MISC0 are 001, 010, 011, and 100, 001, 010, 011, 100 indicate 8-bit, 10-bit, 12-bit, and 16-bit gradations, respectively.

As illustrated in the sixth row of the upper portion of FIG. 10, when the 7-th bit of MISC1 is 0, and 1-st and 2-nd bits of MISC0 are 01 or 10, a 3-rd bit is 1, and a 4-th bit is 0 or 1, it indicates YCbCr (ITU601/ITU709). At this time, when the 1-st and 2-nd bits are 01, it indicates a 422 format, and when the 1-st and 2-nd bits are 10, it indicates a 444 format. Further, at this time, when the 4-th bit is 0, it indicates YCbCr (ITU601), and when the 4-th bit is 1, it indicates YCbCr (ITU709). Furthermore, when the 5-th to 7-th bits of MISC0 are 001, 010, 011, and 100, 001, 010, 011, and 100 indicate 8-bit, 10-bit, 12-bit, and 16-bit gradations, respectively.

As illustrated in the seventh row of the upper portion of FIG. 10, when the 7-th bit of MISC1 is 0, and 1-st and 2-nd bits of MISC0 are 01 or 10, the 3-rd bit is 0, and the 4-th bit is 0 or 1, it indicates xvYCC (xvYCC601/xvYCC709). At this time, when the 1-st and 2-nd bits are 01, it indicates a 422 format, and when the 1-st and 2-nd bits are 10, it indicates a 444 format. Further, when the 4-th bit is 0, it indicates xvYCC (xvYCC601), and when the 4-th bit is 1, it indicates xvYCC (xvYCC709). Furthermore, when the 5-th to 7-th bits of MISC0 are 001, 010, 011, and 100, 001, 010, 011, and 100 indicate 8-bit, 10-bit, 12-bit, and 16-bit gradations, respectively.

As illustrated in the eighth row of the upper portion of FIG. 10, when the 7-th bit of MISC1 is 0, and the 1-st to 4-th bits of MISC0 are 0011, it indicates Adobe (trademark) RGB. Further, when the 5-th to 7-th bits of MISC0 are 000, 001, 010, 011, and 100, 000, 001, 010, 011, and 100 indicate 6-bit, 8-bit, 10-bit, 12-bit, and 16-bit colors, respectively.

As illustrated in the ninth row of the upper portion of FIG. 10, when the 7-th bit of MISC1 is 0, and the 1-st to 4-th bits of MISC0 are 1110, it indicates DCI-P3. Further, when the 5-th to 7-th bits of MISC0 are 011 and 100, 011 and 100 indicate 12-bit and 16-bit colors, respectively.

As illustrated in the tenth row of the upper portion of FIG. 10, when the 7-th bit of MISC1 is 0, and the 1-st to 4-th bits of MISC0 are 1111, it indicates Color Profile. Further, when the 5-th to 7-th bits of MISC0 are 001, 010, 011, and 100, 001, 010, 011, and 100 indicate 8-bit, 10-bit, 12-bit, and 16-bit colors, respectively.

As illustrated in the first row of the lower portion of FIG. 10, a 0-th bit of MISC0 is a (Video Stream_Clk/LS_CLK) synchronous flag between a video stream clock and a link clock, and 0 indicate asynchronous, and 1 indicates synchronous. In the case of synchronous, Mvid has a fixed value.

As illustrated in the second row of the lower portion of FIG. 10, a 0-th bit of MISC1 is an even number flag indicating whether or not a number of Vtotal in the case of interlace is an even number, and 1 indicates an even number, and 0 indicates an odd number.

As illustrated in the third row of the lower portion of FIG. 10, 1-st and 2-nd bits of MISC1 indicates stereo video (3D) characteristics, and 00 indicates transmission of a stereo image using a video stream configuration (VSC) of non-stereo or SDP. Further, when the 1-st and 2-nd bits of MISC1 are 01, it indicates that a next frame is a progressive right-eye image (RIGHT_EYE@Side-by-Side, progressive). At this time, it indicates that a top image is an interface right-eye image (RIGHT_EYE@Top, interlace), and a bottom image is an interface left-eye image (LEFT_EYE@Bottom, interlace). Further, when the 1-st and 2-nd bits of MISC1 are 10, non-set (reserved), and 11, it indicates that a next frame is a progressive left-eye image (LEFT_EYE@Side-by-Side, progressive), a top image is an interface left-eye image (LEFT_EYE@Top, interlace), and a bottom image is an interface right-eye image (RIGHT_EYE@Bottom, interlace).

Here, 4-th to 6-th bits of MISC1 are not set (reserved). Thus, for example, information necessary for specifying a transmission source may be added to the 4-th to 6-th bits of MISC1.

As a result, it is possible to specify a device of a transmission source of visible image data including ZAF image data, and it is possible to make it recognized that a transmission source is an image sensor such as an imaging device by including information indicating that an image transmission source is an image sensor.

<Transceiving Process>

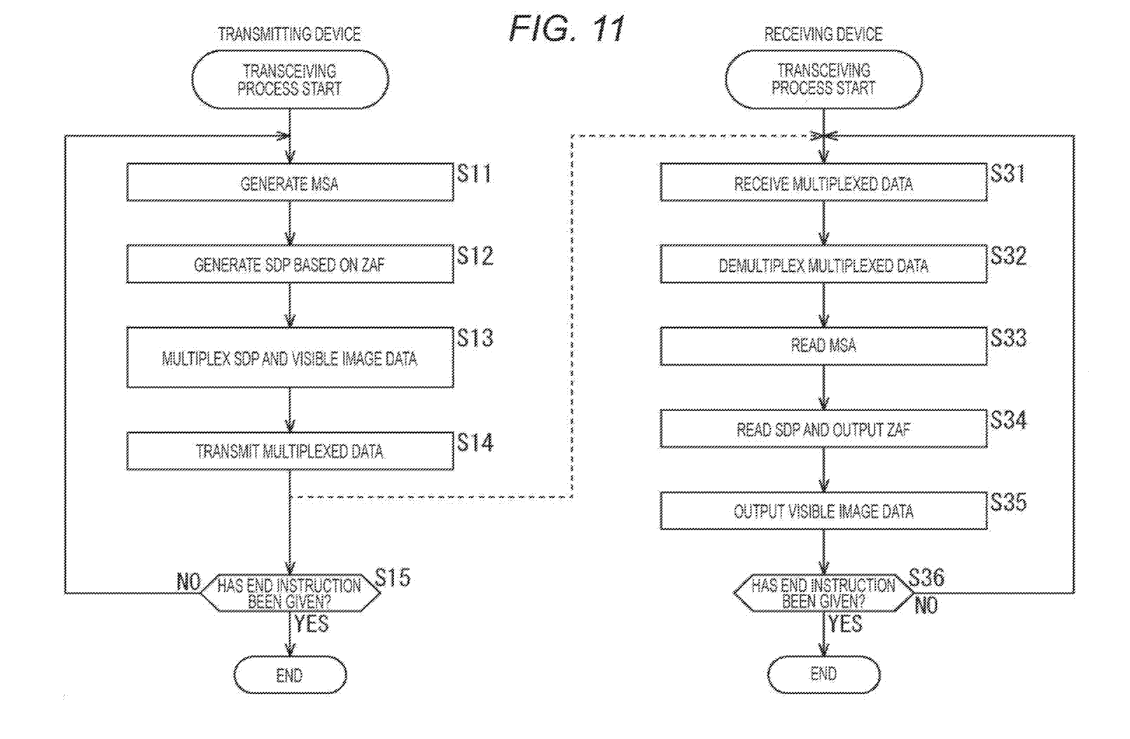

Next, a transceiving process in the transmission system of FIG. 1 will be described with reference to FIG. 11.

In step S11, the MSA generating unit 41 generates the MSA including information of the number of lines per frame, the number of pixels per line, and the number of bits per pixel of the phase detection image data of the visible image data desired to be transmitted, and supplies the generated MSA to the multiplexing unit 43.

In step S12, the SDP generating unit 42 generates the SDP based on the ZAF image data. In other words, the SDP generating unit 42 generates the phase detection image information packet and the phase detection image data packet in the SDP.

In step S13, the multiplexing unit 43 multiplexes the MSA, the SDP, and the visible image data, and generates multiplexed data.

In step S14, the multiplexing unit 43 transmits the multiplexed data to the receiving unit 22.

In step S15, the transmitting unit 21 determines whether or not there is no next image signal, and an end instruction is given, and when no end instruction is given, the process returns to step S11, and the subsequent process is repeated. Further, when an end instruction is given in step S15, the process ends.

Meanwhile, in step S31, in the receiving unit 22, the demultiplexing unit 61 receives the multiplexed data.

In step S32, the demultiplexing unit 61 demultiplexes the multiplexed data into the MSA, the SDP, and the visible image data, and supplies the MSA, the SDP, and the visible image data to the MSA reading unit 62, the SDP reading unit 63, and the image generating unit 64, respectively.

In step S33, the MSA reading unit 62 reads the information of the number of lines per frame, the number of pixels per line, and the number of bits per pixel of the visible image data based on the information of the MSA, and supplies the read information to the image generating unit 64.

In step S34, the SDP reading unit 63 reads the phase detection image information packet and the phase detection image data packet of the SDP, extracts the ZAF image data from the phase detection image data based on the information of the phase detection image information packet, and outputs the ZAF image data.

In step S35, the image generating unit 64 reconstructs the visible image from the visible image data based on the MSA, and outputs the visible image.

In step S36, the receiving unit 22 determines whether or not there is no next image signal, and an end instruction is given, and when no end instruction is given, the process returns to step S31, and the subsequent process is repeated. Further, when an end instruction is given in step S36, the process ends.

Through the above process, as the SDP is used, and the ZAF image data is packetized, it is possible to transmit the visible image data and adds the packetized ZAF image data to the horizontal blanking region and the vertical blanking region and transmit the resultant data.

### 2. Second Embodiment

### Exemplary Configuration of Transmission System Using Virtual Channel

The above description has been made in connection with the example in which the ZAF image data is transmitted using the SDP together with the visible image data, but, for example, the transmission may be performed using a virtual channel format specified in the DisplayPort (trademark).

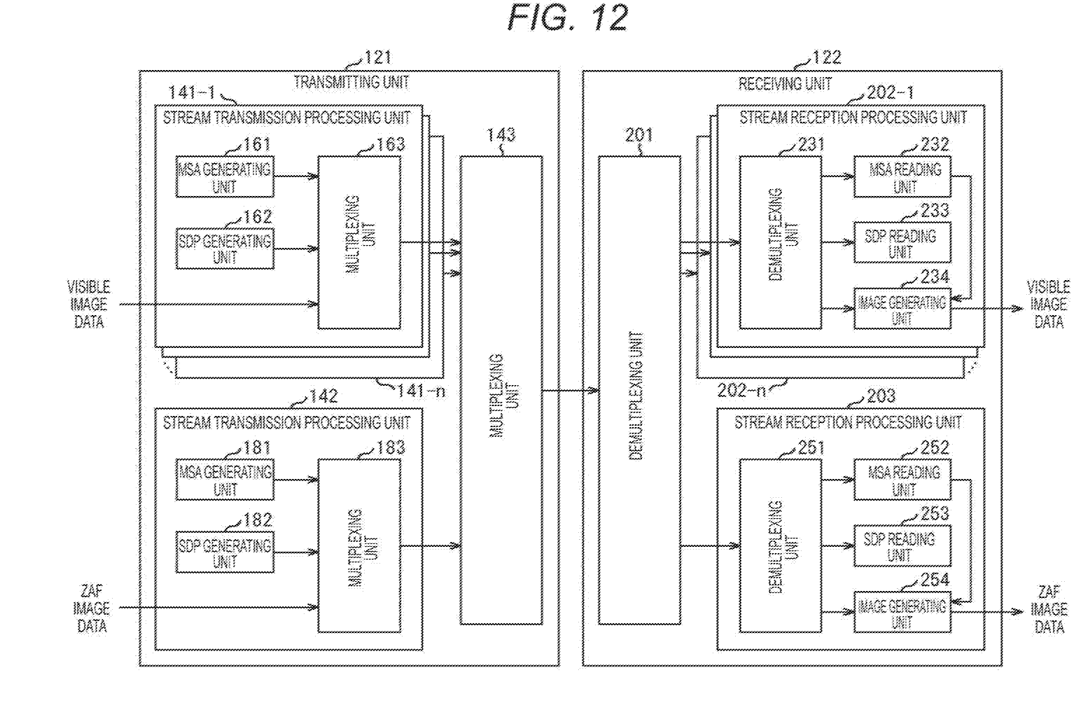

FIG. 12 illustrates an exemplary configuration of a transmission system configured to transmit ZAF image data together with visible image data using a virtual channel format.

Here, a virtual channel refers to a scheme in which a plurality of streams are transmitted from a plurality of stream sources to a plurality of stream sinks through a single transmission path. In the transmission system of FIG. 12, visible image data and a stream of ZAF image data including ZAF pixel data are set to one of a plurality of stream sources and transmitted together with a stream including visible image data using a virtual channel.

More specifically, the transmission system of FIG. 12 includes a transmitting unit 121 and a receiving unit 122.

The transmitting unit 121 includes stream transmission processing units 141-1 to 141-n and a stream transmission processing unit 142.

The stream transmission processing units 141-1 to 141-n includes an MSA generating unit 161, an SDP generating unit 162, and a multiplexing unit 163, generates stream data including visible image data, and outputs the stream data to a multiplexing unit 143. Here, the functions of the MSA generating unit 161, the SDP generating unit 162, and the multiplexing unit 163 are basically the same as the functions of the MSA generating unit 41, the SDP generating unit 42, and the multiplexing unit 43 described above with reference to FIG. 1, and thus a description thereof is omitted. Here, in this example, the SDP generating unit 162 does not function.

Further, the stream transmission processing unit 142 includes an MSA generating unit 181, an SDP generating unit 182, and a multiplexing unit 183, generates stream data including ZAF image data configured with ZAF pixel, and outputs the stream data to the multiplexing unit 143. Here, the functions of the MSA generating unit 181, the SDP generating unit 182, and the multiplexing unit 183 are basically the same as the functions of the MSA generating unit 41, the SDP generating unit 42, and the multiplexing unit 43 described above with reference to FIG. 1, and thus a description thereof is omitted. Here, in this example, the SDP generating unit 182 does not function.

The multiplexing unit 143 transmits multiplexed data obtained by time division multiplexing the stream data including the visible image data supplied from the plurality of streams transmission processing units 141-1 to 141-n and the stream data including the ZAF image data supplied from the stream transmission processing unit 142 to the receiving unit 122.

The receiving unit 122 includes a demultiplexing unit 201, stream reception processing units 202-1 to 202-n, and a stream reception processing unit 203.

The demultiplexing unit 201 demultiplexes the multiplexed data transmitted from the transmitting unit 121 into a plurality of pieces of stream data including a plurality of pieces of visible image data and stream data including ZAF image data, and the demultiplexed stream data including the visible image data and the stream data including the ZAF image data to the stream reception processing units 202-1 to 202-n and the stream reception processing unit 203, respectively.

The stream reception processing unit 202-1 includes a demultiplexing unit 231, an MSA reading unit 232, an SDP reading unit 233, and an image generating unit 234, generates visible image data based on the stream data including a plurality of pieces of visible image data, and outputs the generated visible image data. Here, the demultiplexing unit 231, the MSA reading unit 232, the SDP reading unit 233, and the image generating unit 234 have basically the same functions as the demultiplexing unit 61, the MSA reading unit 62, the SDP reading unit 63, and the image generating unit 64 described above with reference to FIG. 1, and thus a description thereof is omitted. Here, the SDP reading unit 233 does not function.

The stream reception processing unit 202-2 includes a demultiplexing unit 251, an MSA reading unit 252, an SDP reading unit 253, and an image generating unit 254, generates a ZAF image based on the stream data including the ZAF image data, and outputs the generated ZAF image. Here, the demultiplexing unit 251, the MSA reading unit 252, and the SDP reading unit 253 have basically the same functions as the demultiplexing unit 61, the MSA reading unit 62, the SDP reading unit 63, and the image generating unit 64 described above with reference to FIG. 1, and thus a description thereof is omitted. Here, the SDP reading unit 253 does not function.

<ZAF Image>

Next, a ZAF image generated when a virtual channel format is used will be described.

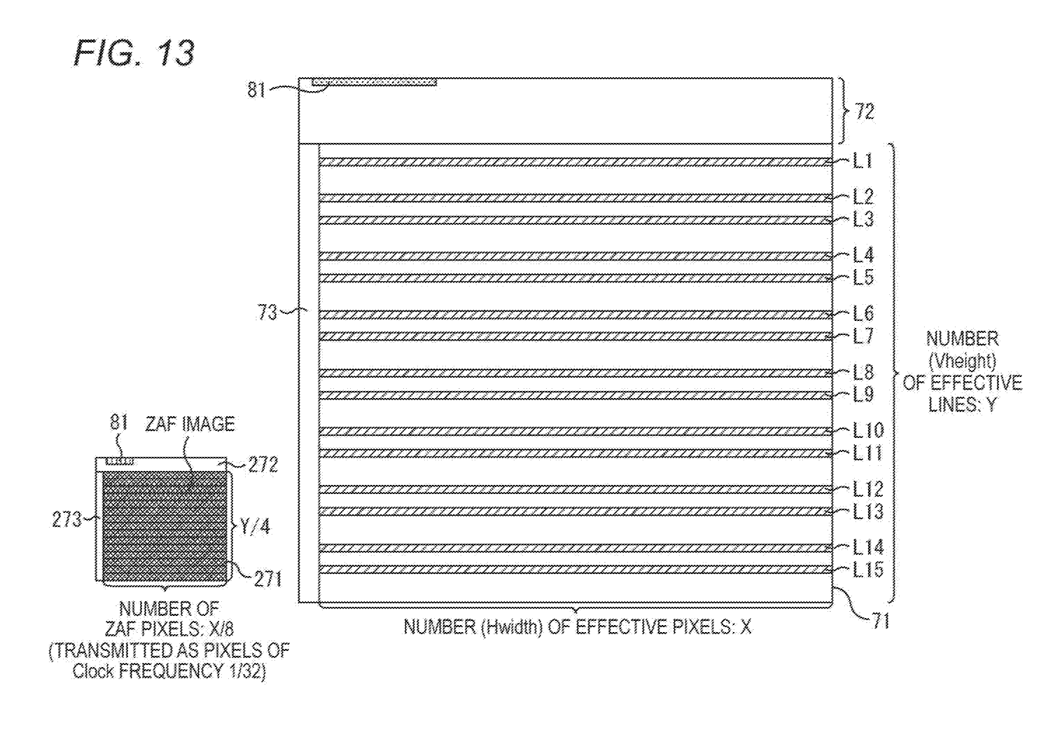

A ZAF image is an image configured with ZAF pixels. For example, a ZAF image is an image that is substantially the same as an image configured by combining ZAF pixels configuring the phase detection image data packets 83-1 to 83-15 described above with reference to FIG. 3 in the vertical direction and the horizontal direction, and is an image illustrated at the left portion of FIG. 13.

In this case, a ZAF image is configured with a ZAF pixel region 271 corresponding to the effective pixel region 71, a vertical blanking region 272 corresponding to the vertical blanking region 72, and a horizontal blanking region 273 corresponding to the horizontal blanking region 73.

In other words, the ZAF pixel region 271 of the ZAF image in the left portion of FIG. 13 is ¼ of the effective pixel region 71 of the visible image in the number of effective lines in the vertical direction and ⅛ of the effective pixel region 71 of the visible image in the number of effective pixels in the horizontal direction.

In the transmission system of FIG. 12, as illustrated in FIG. 13, two types of images of the visible image data including the effective pixel data and the ZAF image including the ZAF pixel data are set, then converted into individual streams, and transmitted using a virtual channel. As a result, the visible image data is transmitted together with the ZAF pixel data.

<Time Division Multiplexing>

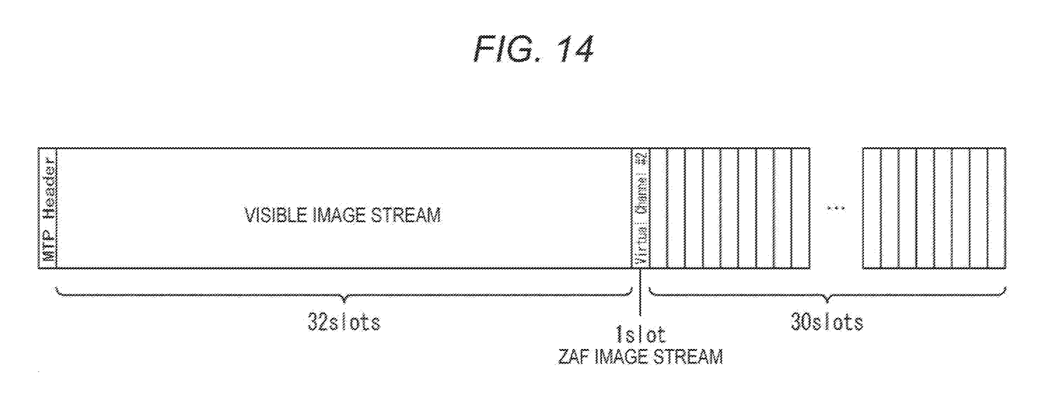

When a virtual channel is used, according to the DisplayPort (trademark), time slots can be divided into 63. For this reason, for example, when the visible image data and the ZAF image data illustrated in FIG. 13 are transmitted, and time division multiplexing is performed at a ratio of the number of pixels of both data, if 32 time slots are allocated to a stream including visible image data as illustrated in FIG. 14, one time slot is allocated to a stream including ZAF pixel data.

In other words, when a virtual channel is used, as time division multiplexing and transmission are performed, two streams (a visible image stream and a ZAF image stream) are transmitted from two stream sources (a visible image stream source and a ZAF image stream source) to two stream sinks (a visible image stream sink and a ZAF image stream sink) through one transmission path. As a result, the ZAF image data can be transmitted together with the visible image data.

Here, in FIG. 14, the remaining 30 slots may be used as blanks or may be allocated a stream including another image. Further, since a maximum of 63 slots are specified to be allocated, the number of streams that can be transmitted and received is a maximum of 63, and when at least one stream is allocated to the ZAF image data, the maximum number n of the stream transmission processing units 141-1 to 141-n that transmit the visible image data and the stream reception processing units 202-1 to 202-n that receive the visible image data is regarded to be 62 (n=62).

<Comparison of MSA between visible image and ZAF image>

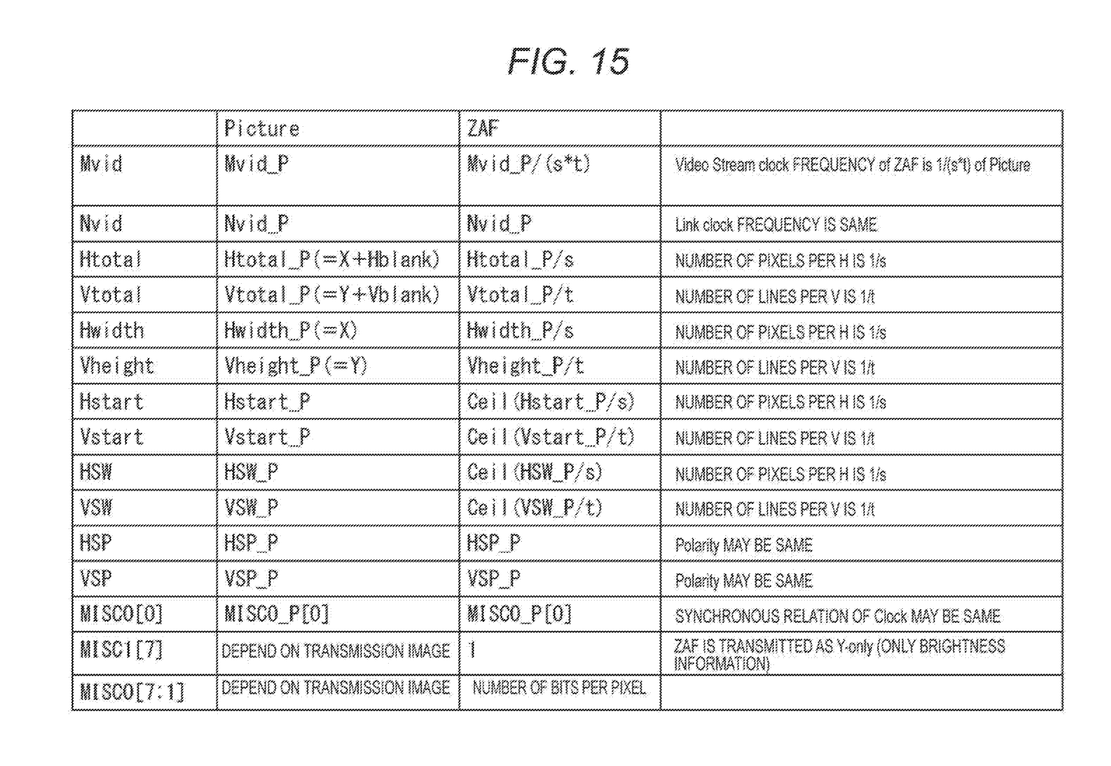

Next, a comparison of an MSA between a visible image and a ZAF image will be described with reference to FIG. 15. Here, the number of pixels in the horizontal direction and the number of pixels in the vertical direction in a ZAF image are described to be 1/s and 1/t of the number of pixels in the horizontal direction and the number of pixels in the vertical direction in a visible image. In FIG. 15, Picture indicates a visible image, and ZAF indicates a ZAF image.

As illustrated in the first row of FIG. 15, a video stream clock frequency Mvid of the ZAF image is Mvid_P/(s×t) when a video stream clock frequency of the visible image is Mvid_P. Here, in FIG. 15, “*” indicates “x.”

As illustrated in the second row of FIG. 15, a link clock frequency Nvid of the ZAF image is equal to Nvid_P when a link clock frequency of the visible image is Nvid_P.

As illustrated in the third row of FIG. 15, the total number of pixels Htotal of the effective pixel region configuring the visible image and the horizontal blanking region in the horizontal direction is Htotal_P/s for the ZAF image when that for the visible image is Htotal_P(=X+Hblank).

As illustrated in the fourth row of FIG. 15, the total number of lines Vtotal of the visible image and the vertical blanking region in the vertical direction is Vtotal_P/t for the ZAF image when that for the visible image is Vtotal_P(=Y+Vblank).

As illustrated in the fifth row of FIG. 15, the total number of pixels Hwidth of the visible image in the horizontal direction is Hwidth_P/s for the ZAF image when that for the visible image is Hwidth_P(=X).

As illustrated in the sixth row of FIG. 15, the total number of pixels Vheight of the visible image in the vertical direction is Vheight_P/t for the ZAF image when that for the visible image is Vheight_P(=Y).

As illustrated in the seventh row of FIG. 15, the number of start pixels Hstart of Hsync (a horizontal synchronous signal) is Ceil(Hstart_P/s) for the ZAF image when that for the visible image is Hstart_P. Here, Ceil(A) is a function of rounding out a fractional point of A.

As illustrated in the eighth row of FIG. 15, the number of start pixels Vstart of Vsync (a vertical synchronous signal) is Ceil(Vstart_P/t) for the ZAF image when that for the visible image is Vstart_P.

As illustrated in the ninth row of FIG. 15, the pulse width HSW of Hsync is Ceil(HSW_P/s) for the ZAF image when that for the visible image is HSW_P.

As illustrated in the tenth row of FIG. 15, when the pulse width VSW of Vsync is Ceil(VSW_P/t) for the ZAF image when that for the visible image is VSW_P.

As illustrated in the eleventh to thirteenth row of FIG. 15, the visible image and the ZAF image are the same in the polarities HSP and VSP of Hsync and Vsync and the 0-th bit of MISC0.

As illustrated in the fourteenth row of FIG. 15, in the visible image, the 7-th bit of MISC1 depends on a pixel configuration of a transmission image, whereas in the ZAF image, the 7-th bit of MISC1 is set to 1 and indicates only brightness information.

As illustrated in the fifteenth row of FIG. 15, in the visible image, the 1-st to 7-th bits of MISC0 depend on a transmission image, whereas in the ZAF image, the 1-st to 7-th bits of MISC0 indicate information of the number of bits per pixel.

In other words, as illustrated in FIG. 15, when the ZAF image is dealt, it is necessary to set the MSA corresponding to the ZAF image.

<Transceiving Process>

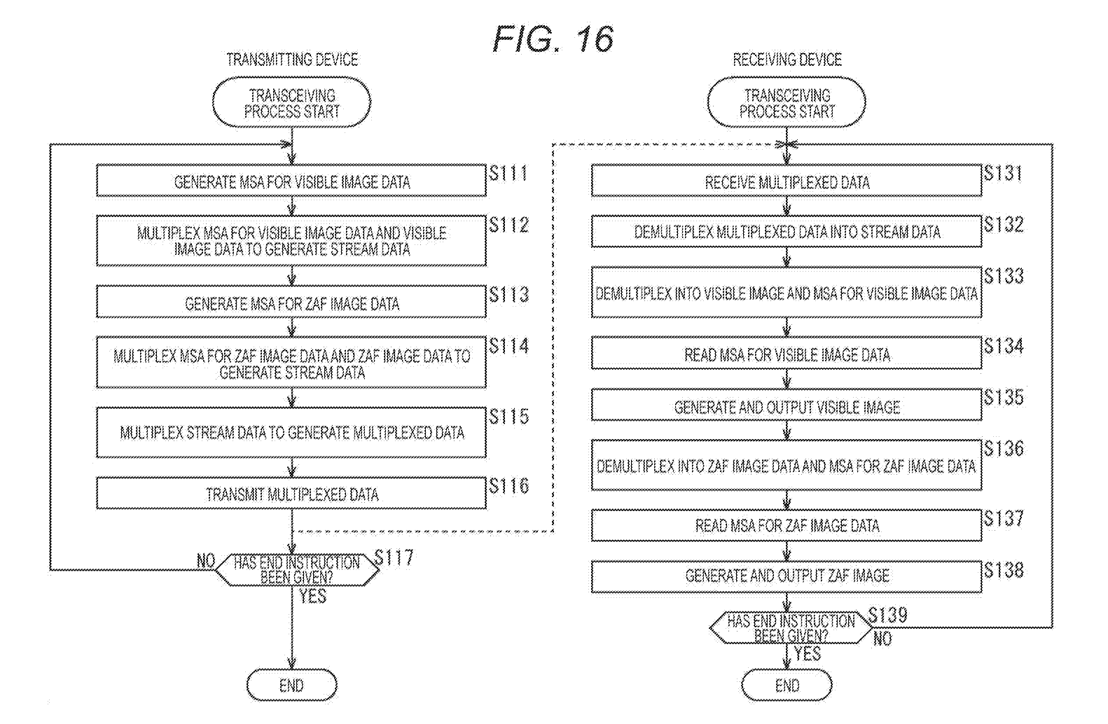

Next, a transceiving process when the ZAF image data is transmitted together with the visible image data in the transmission system of FIG. 9 will be described with reference to a flowchart of FIG. 16.

In step S111, the MSA generating unit 161 of the stream transmission processing unit 141 generates the MSA for the visible image data, and outputs the MSA for the visible image data to the multiplexing unit 163.

In step S112, the multiplexing unit 163 multiplexes the supplied visible image data and the MSA for the visible image data to generate the stream data including the visible image data, and supplies the generated stream data to the multiplexing unit 143.

In step S113, the MSA generating unit 181 of the stream transmission processing unit 142 generates the MSA for the ZAF image data, and outputs the MSA for the ZAF image data to the multiplexing unit 183.

In step S114, the multiplexing unit 183 multiplexes the supplied ZAF image data and the MSA for the ZAF image data to generate the stream data including the ZAF image data, and supplies the generated stream data to the multiplexing unit 143.

In step S115, the multiplexing unit 143 performs time division multiplexing on the supplied stream data including the visible image data and the stream data including the ZAF image data according to the virtual channel format.

In step S116, the multiplexing unit 143 transmits the multiplexed data generated by the multiplexing to the receiving unit 122.

In step S117, the transmitting unit 121 determines whether or not there is no next image signal, and an end instruction is given, and when no end instruction is given, the process returns to step S111, and the subsequent process is repeated. Further, when an end instruction is given in step S117, the process ends.

Meanwhile, in the receiving unit 122, in step S131, the demultiplexing unit 201 of the receiving unit 122 receives the transmitted multiplexed data.

In step S132, the demultiplexing unit 201 of the receiving unit 122 demultiplexes the received multiplexed data into the stream data including the visible image data and the stream data including the ZAF image data according to the virtual channel format, and supplies the stream data including the visible image data and the stream data including the ZAF image data to the stream reception processing units 202 and 203.

In step S133, the demultiplexing unit 231 of the stream reception processing unit 202 demultiplexes the stream data including the visible image data into the MSA for the visible image and the visible image data, and outputs the MSA for the visible image and the visible image data to the MSA reading unit 232 and the image generating unit 234, respectively.

In step S134, the MSA reading unit 232 reads the MSA, and supplies information of the read MSA to the image generating unit 234.

In step S135, the image generating unit 234 reconstructs the visible image from the visible image data based on the information of the MSA, and outputs the reconstructed visible image.

In step S136, the demultiplexing unit 251 of the stream reception processing unit 203 multiplexes the stream data including the visible image data into the MSA for the ZAF image and the ZAF image data, and outputs the MSA for the ZAF image and the ZAF image data to the MSA reading unit 252 and the image generating unit 254, respectively.

In step S137, the MSA reading unit 252 reads the MSA for the ZAF image, and supplies information of the reads MSA to the image generating unit 254.

In step S138, the image generating unit 254 reconstructs the ZAF image from the ZAF image data based on the information of the MSA for the ZAF image, and outputs the reconstructed ZAF image.

In step S139, the receiving unit 122 determines whether or not there is no next image signal, and an end instruction is given, and when no end instruction is given, the process returns to step S131, and the subsequent process is repeated. Further, when an end instruction is given in step S139, the process ends.

Through the above process, the ZAF image and the visible image data are converted into streaming data, and thus it is possible to the ZAF pixel data while transmitting the effective pixel data serving as the visible image data using the virtual channel.

Meanwhile, a series of processes described above can be implemented by hardware and can be implemented by software as well. When a series of processes are implemented by software, a program configuring the software is installed in a computer incorporated in dedicated hardware, a general-purpose personal computer capable of executing various kinds of functions through various kinds of programs installed therein, or the like from a recording medium.

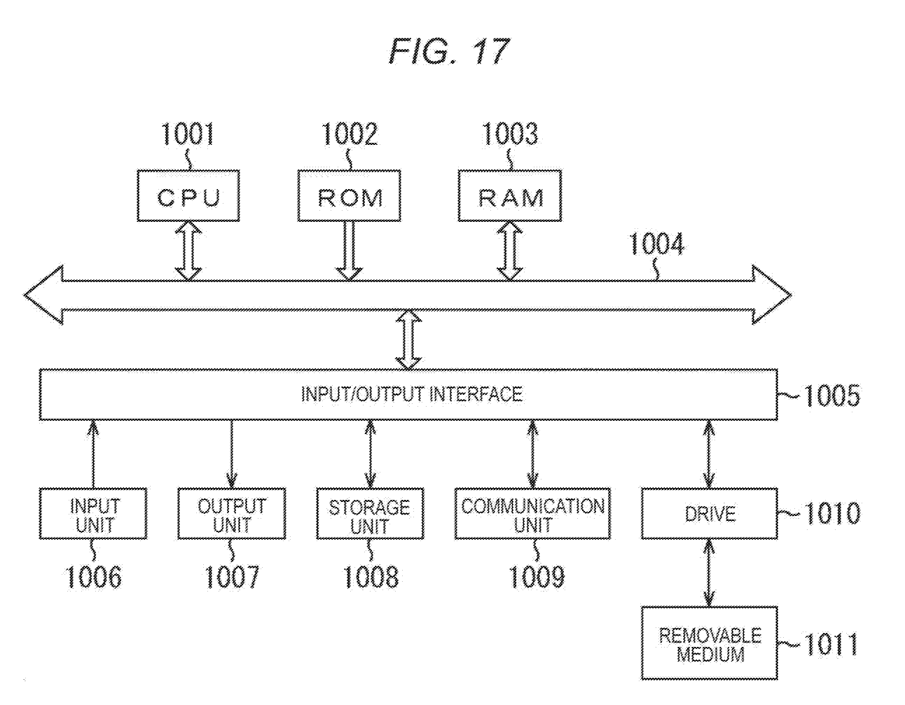

FIG. 17 illustrates an exemplary configuration of a general-purpose personal computer. The personal computer includes a central processing unit (CPU) 1001 therein. An input/output interface 1005 is connected to the CPU 1001 via a bus 1004. A read only memory (ROM) 1002 and a random access memory (RAM) 1003 are connected to the bus 1004.

An input unit 1006 including an input device such as a keyboard or a mouse used when the user inputs an operation command, an output unit 1007 that outputs a processing operation screen or a processing result image to a display device, a storage unit 1008 including a hard disk drive storing a program or various kinds of data, and a communication unit 1009 that includes a local area network (LAN) adaptor or the like and performs communication processing via a network represented by the Internet are connected to the input/output interface 1005. Further, a drive 1010 that reads or writes data from or to a removable medium 1011 such as a magnetic disk (including a flexible disk), an optical disk (including a compact disc-read only memory (CD-ROM) and a digital versatile disc (DVD)), a magneto-optical disk (including a mini disc (MD)), or a semiconductor memory is connected to the input/output interface 1005.

The CPU 1001 executes various kinds of processes according to a program stored in the ROM 1002 or a program that is read from the removable medium 1011 such as a magnetic disk, an optical disk, a magneto-optical disk, or a semiconductor memory, installed in the storage unit 1008, and loaded onto the RAM 1003 from the storage unit 1008. The RAM 1003 also appropriately stores data necessary when the CPU 1001 executes various kinds of processes.

In the computer having the above configuration, for example, a series of processes described above are performed such that the CPU 1001 loads the program stored in the storage unit 1008 onto the RAM 1003 through the input/output interface 1005 and the bus 1004 and executes the program.

For example, the program executed by the computer (the CPU 1001) may be recorded in the removable medium 1011 serving as a package medium and provided. Further, the program may be provided through a wired or wireless transmission medium such as a LAN, the Internet, or digital satellite broadcasting.

In the computer, as the removable medium 1011 is mounted in the drive 1010, the program can be installed in the storage unit 1008 through the input/output interface 1005. Further, the program may be received through the communication unit 1009 via a wired or wireless transmission medium and installed in the storage unit 1008. Furthermore, the program may be installed in the ROM 1002 or the storage unit 1008 in advance.

Further, the program executed by the computer may be a program in which processes are chronologically performed according to the order described in this specification or a program in which processes are performed in parallel or according to a necessary timing when called.

In addition, in this specification, a system means a set of two or more configuration elements (devices, modulates (parts), or the like) regardless of whether or not all configuration elements are arranged in a single housing. Thus, both a plurality of devices that are accommodated in separate housings and connected via a network and a single device in which a plurality of modules are accommodated in a single housing are systems.

Further, an embodiment of the present technology is not limited to the above embodiments, and various changes can be made within the scope not departing from the gist of the present technology.

For example, the present technology may have a configuration of cloud computing in which a plurality of devices share and process a one function together via a network.

Further, the steps described in the above flowcharts may be executed by a single device or may be shared and executed by a plurality of devices.

Furthermore, when a plurality of processes are included in a single step, the plurality of processes included in the single step may be executed by a single device or may be shared and executed by a plurality of devices.

Further, the present technology may have the following configurations.

(1) A transmitting device that transmits visible image data including effective pixel data of an imaging device using a format for transmission to a display, the transmitting device including:
a transmitting unit that transmits phase detection image data in the imaging device in addition to the visible image data.
(2) The transmitting device according to (1), wherein the transmitting unit packetizes and transmits the phase detection image data in the imaging device using the format for the transmission to the display.
(3) The transmitting device according to (2), wherein the format for the transmission to the display is a format specified in a DisplayPort (trademark), and the transmitting unit packetizes and transmits the phase detection image data in the imaging device using a secondary data packet (SDP) specified in the DisplayPort (trademark) as the format for the transmission to the display.
(4) The transmitting device according to (3),
wherein the transmitting unit packetizes and transmits the phase detection image data in the imaging device using a phase detection image information packet and a phase detection image data packet of the SDP specified in the DisplayPort (trademark).
(5) The transmitting device according to (4),
wherein the transmitting unit arranges the phase detection image information packet in a vertical blanking region, arranges the phase detection image data packet in a horizontal blanking region, and packetizes and transmits the phase detection image data.
(6) The transmitting device according to (4) or (5), wherein the phase detection image information packet includes information of the number of lines per frame, the number of pixels per line, and the number of bits per pixel of a phase detection image configured with the phase detection image data and the number of pixels per the phase detection image data.
(7) The transmitting device according to any one of (4) to (6), wherein the transmitting unit packs the phase detection image data packet in a certain byte unit and transmits the packed phase detection image data packet.
(8) The transmitting device according to (1),
wherein the transmitting unit transmits the phase detection image data in the imaging device in addition to the visible image data using a scheme in which a plurality of streams are transmitted from a plurality of stream sources to a plurality of stream sinks through one transmission path in the format for the transmission to the display.
(9) The transmitting device according to (8),
wherein the format for the transmission to the display is a format specified in a DisplayPort (trademark), and
the transmitting unit transmits the phase detection image data in the imaging device in addition to the visible image data by transmitting a stream including the visible image data and a stream including the phase detection image data from the stream sources to the stream sinks through one transmission path using a virtual channel specified in the DisplayPort (trademark).
(10) The transmitting device according to (9),
wherein a main stream attributes (MSA) that is individually for each stream of the virtual channel and is image characteristic information of the stream includes information of the number of lines per frame, the number of pixels per line, and the number of bits per pixel of a phase detection image configured with the phase detection image data when the steam is a stream including the phase detection image data.
(11) The transmitting device according to (10), wherein the MSA further includes information of Mvid (a video stream clock frequency) and Nvid (a link clock frequency), and when the number of pixels in the vertical direction and the number of pixels in the horizontal direction in the phase detection image including the phase detection image data is 1/t and 1/s of the number of pixels in the vertical direction and the number of pixels in the horizontal direction of a visible image including the visible image data, respectively, a ratio of the Mvid and the Nvid of the MSA of the phase detection image data is 1/(t×s) of a ratio of the Mvid and the Nvid of the MSA of the visible image data.
(12) The transmitting device according to (10) or (11), wherein the MSA further includes information specifying the imaging device.
(13) A transmitting method of a transmitting device that transmits visible image data including effective pixel data of an imaging device using a format for transmission to a display, the transmitting method including:
transmitting phase detection image data in the imaging device in addition to the visible image data.
(14) A non-transitory computer-readable storage medium storing program causing a computer controlling a transmitting device that transmits visible image data including effective pixel data of an imaging device using a format for transmission to a display to execute:
a process including transmitting phase detection image data in the imaging device in addition to the visible image data.
(15) A receiving device that receives visible image data including effective pixel data of an imaging device using a format for transmission to a display, the receiving device including:
a receiving unit that receives a phase detection image data in the imaging device in addition to the visible image data.
(16) A receiving method of a receiving device that receives visible image data including effective pixel data of an imaging device using a format for transmission to a display, the receiving method including:
receiving a phase detection image data in the imaging device in addition to the visible image data.
(17) A non-transitory computer-readable storage medium storing program causing a computer controlling a receiving device that receives visible image data including effective pixel data of an imaging device using a format for transmission to a display to execute:
a process including receiving a phase detection image data in the imaging device in addition to the visible image data.
(18) A transmission system, including:
a transmitting device that transmits visible image data including effective pixel data of an imaging device using a format for transmission to a display;
a receiving device,
wherein the transmitting device includes a transmitting unit that transmits phase detection image data in the imaging device in addition to the visible image data to the receiving device, and the receiving device includes a receiving unit that receives a phase detection image data in the imaging device in addition to the visible image data from the transmitting device.

### REFERENCE SIGNS LIST

21 Transmitting unit
22 Receiving unit
41 MSA generating unit
42 SDP generating unit
43 Multiplexing unit
61 Demultiplexing unit
62 MSA reading unit
63 SDP reading unit
64 Image generating unit
121 Transmitting unit
122 Receiving unit
141, 141-1 to 141-n, 142 Stream transmission processing unit
143 Multiplexing unit
161 MSA generating unit
162 SDP generating unit
163 Multiplexing unit
181 MSA generating unit
182 SDP generating unit
183 Multiplexing unit
201 Demultiplexing unit
202,202-1 to 202-n,203 Stream reception processing unit
231 Demultiplexing unit
232 MSA reading unit
233 SDP reading unit
234 Image generating unit
251 Demultiplexing unit
252 MSA reading unit
253 SDP reading unit
254 Image generating unit

1. A transmitting device that transmits visible image data including effective pixel data of an imaging device using a format for transmission to a display, the transmitting device comprising:
a transmitting unit that transmits phase detection image data in the imaging device in addition to the visible image data.

2. The transmitting device according to claim 1,
wherein the transmitting unit packetizes and transmits the phase detection image data in the imaging device using the format for the transmission to the display.

3. The transmitting device according to claim 2,
wherein the format for the transmission to the display is a format specified in a DisplayPort (trademark), and
the transmitting unit packetizes and transmits the phase detection image data in the imaging device using a secondary data packet (SDP) specified in the DisplayPort (trademark) as the format for the transmission to the display.

4. The transmitting device according to claim 3,
wherein the transmitting unit packetizes and transmits the phase detection image data in the imaging device using a phase detection image information packet and a phase detection image data packet of the SDP specified in the DisplayPort (trademark).

5. The transmitting device according to claim 4,
wherein the transmitting unit arranges the phase detection image information packet in a vertical blanking region, arranges the phase detection image data packet in a horizontal blanking region, and packetizes and transmits the phase detection image data.

6. The transmitting device according to claim 4,
wherein the phase detection image information packet includes information of the number of lines per frame, the number of pixels per line, and the number of bits per pixel of a phase detection image configured with the phase detection image data and the number of pixels per the phase detection image data.

7. The transmitting device according to claim 4,
wherein the transmitting unit packs the phase detection image data packet in a certain byte unit and transmits the packed phase detection image data packet.

8. The transmitting device according to claim 1,
wherein the transmitting unit transmits the phase detection image data in the imaging device in addition to the visible image data using a scheme in which a plurality of streams are transmitted from a plurality of stream sources to a plurality of stream sinks through one transmission path in the format for the transmission to the display.

9. The transmitting device according to claim 8,
wherein the format for the transmission to the display is a format specified in a DisplayPort (trademark), and
the transmitting unit transmits the phase detection image data in the imaging device in addition to the visible image data by transmitting a stream including the visible image data and a stream including the phase detection image data from the stream sources to the stream sinks through one transmission path using a virtual channel specified in the DisplayPort (trademark).

10. The transmitting device according to claim 9,
wherein a main stream attributes (MSA) that is individually for each stream of the virtual channel and is image characteristic information of the stream includes information of the number of lines per frame, the number of pixels per line, and the number of bits per pixel of a phase detection image configured with the phase detection image data when the steam is a stream including the phase detection image data.

11. The transmitting device according to claim 10,
wherein the MSA further includes information of Mvid (a video stream clock frequency) and Nvid (a link clock frequency), and
when the number of pixels in the vertical direction and the number of pixels in the horizontal direction in the phase detection image including the phase detection image data is 1/t and 1/s of the number of pixels in the vertical direction and the number of pixels in the horizontal direction of a visible image including the visible image data, respectively, a ratio of the Mvid and the Nvid of the MSA of the phase detection image data is 1/(t×s) of a ratio of the Mvid and the Nvid of the MSA of the visible image data.

12. The transmitting device according to claim 10,
wherein the MSA further includes information specifying the imaging device.

13. A transmitting method of a transmitting device that transmits visible image data including effective pixel data of an imaging device using a format for transmission to a display, the transmitting method comprising:
transmitting phase detection image data in the imaging device in addition to the visible image data.

14. A non-transitory computer-readable storage medium storing program causing a computer controlling a transmitting device that transmits visible image data including effective pixel data of an imaging device using a format for transmission to a display to execute:
a process including transmitting phase detection image data in the imaging device in addition to the visible image data.

15. A receiving device that receives visible image data including effective pixel data of an imaging device using a format for transmission to a display, the receiving device comprising:
a receiving unit that receives a phase detection image data in the imaging device in addition to the visible image data.

16. A receiving method of a receiving device that receives visible image data including effective pixel data of an imaging device using a format for transmission to a display, the receiving method comprising:
receiving a phase detection image data in the imaging device in addition to the visible image data.

17. A non-transitory computer-readable storage medium storing program causing a computer controlling a receiving device that receives visible image data including effective pixel data of an imaging device using a format for transmission to a display to execute:
a process including receiving a phase detection image data in the imaging device in addition to the visible image data.

18. A transmission system, comprising:
a transmitting device that transmits visible image data including effective pixel data of an imaging device using a format for transmission to a display; and
a receiving device,
wherein the transmitting device includes a transmitting unit that transmits phase detection image data in the imaging device in addition to the visible image data to the receiving device, and
the receiving device includes a receiving unit that receives a phase detection image data in the imaging device in addition to the visible image data from the transmitting device.
